(19) United States
(12) Patent Application Publication
(10) Pub. No.: US 2023/0294610 A1
(43) Pub. Date: Sep. 21, 2023

(54) CONNECTION FRAME FOR CONSOLE OF VEHICLE

(71) Applicant: SHINKI INTER-MOBIL CO., LTD., Busan (KR)

(72) Inventors: Kyoung Sik KIM, Ansan-si (KR); Sang Jin JOUNG, Ulsan (KR); Hong Kil NOH, Asan-si (KR)

(21) Appl. No.: 17/849,052

(22) Filed: Jun. 24, 2022

(30) Foreign Application Priority Data
Mar. 15, 2022 (KR) 10-2022-0031878

(51) Int. Cl. B60R 7/04

(52) U.S. Cl. CPC B60R 7/04

(57) ABSTRACT

Disclosed herein is a connection frame for a console of vehicle. The connection frame is to connect a storage box and an armrest. And the connection frame includes a lower frame and an upper frame. The lower frame having rectangular shape is fixed to the storage box. And the upper frame extends upward from the lower frame to support the side lids mounted at both sides of the armrest. The side lid includes an outer cover and an inner cover, and an upper frame. The outer frame cover and the inner cover to couple and support the outer cover and the inner cover.

### CROSS-REFERENCE TO REPLATED APPLICATIONS

The present application is based upon and claims the benefit of priority to Korean Patent Application No. 10-2022-0031878 filed on Mar. 15, 2022, in the Korean Intellectual Property Office, which is incorporated herein by reference in its entirety.

### BACKGROUND OF THE INVENTION

### Field of the Invention

The present invention relates to a connection frame for a console of a vehicle, and more specifically, to a connection frame for a console which connects a storage box of a console and an armrest to support opening and closing of the armrest with sufficient structural strength.

### Background Art

In general, a console is installed between a driver seat and a passenger seat of a vehicle. Such a console includes a storage box mounted at a lower part and an armrest for opening and closing the upper portion of the storage box. Moreover, the armrest includes side lids fixed to both sides of the storage box located at the lower part, and a center lid mounted between the side lids to be opened and closed.

In substance, the center lid of the armrest opens and closes a storage room inside the storage box. Traditionally, because the armrest is mainly used by a driver, it is configured to be opened unidirectionally from the front to the rear. However, by various requests, Korean Utility Model Application No. 20-1994-0031556 (filed on Nov. 28, 1994) and Korean Patent Application No. 10-2004-0097620 (filed on Nov. 25, 2004) proposed armrest configured to be selectively opened from the front or the rear.

Especially, when an armrest which is opened and closed bidirectionally is designed, a connection structure between the armrest and a storage box located at the lower part is structurally important. Even in the case that an armrest is designed not to be opened and closed bidirectionally but to be opened and closed in one direction, it is preferable to provide structural strength to the connection structure between the storage box and the armrest.

### SUMMARY OF THE INVENTION

Therefore, it is an object of the present invention to provide a connection frame designed to sufficiently secure structural strength in opening and closing an armrest supported on an upper portion of a storage box.

The connection frame proposed by the present invention may be considered to reinforce structural strength of an armrest which is substantially opened and closed bidirectionally. For instance, the connection frame according to the present invention is applicable not only to bidirectional opening and closing structures of conventional arts or currently commercialized armrests but also to all structures which can selectively open and close an armrest in the back-and-forth direction or bidirectionally. In addition, even though the armrest is not opened and closed bidirectionally, the connection frame according to the present invention can be used as a supporter for reinforcing the basic strength to support the armrest.

To accomplish the above object, according to the present invention, there is provided a connection frame for a console of a vehicle for connecting a storage box having an open upper portion and an armrest having side lids mounted at both sides of the upper portion of the storage box and a center lid which is supported by the side lids to open and close the storage box. Moreover, the connection frame includes: a lower frame of which at least a portion gets in contact with the outer side surface of the storage box and is fixed to the storage box, and which has a rectangular shape; and an upper frame extending upward from the lower frame to support the side lids mounted at both sides of the armrest.

According to another embodiment of the present invention, the side lid includes an outer cover and an inner cover, and the upper frame is interposed between the outer cover and the inner cover to couple and support the outer cover and the inner cover.

According to the present invention having the above structure, the storage box of the console and the side lids of the armrest are connected to each other and are supported by the connection frame made of aluminum diecasting. The metal connection frame according to the present invention can improve the overall strength of the console, and allows the base of the support structure to be designed in a more robust structure since the lower frame is formed in the rectangular shape to surround the entire storage box. Additionally, in the case that the connection frame of the present invention is designed such that the armrest of the console can be opened and closed bidirectionally, it is possible to design the console to have a sufficient support strength for bidirectional opening and closing.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a view illustrating a console to which the present invention is applied;

FIG. 2 is a perspective view illustrating a configuration of a connection frame according to the present invention; and

FIG. 3 is a perspective view illustrating a vertical support structure by the connection frame according to the present invention.

### DETAILED DESCRIPTION OF THE PREFERRED EMBODIMENT

Hereinafter, the present invention will be described in more detail with reference to the embodiment illustrated in the drawings.

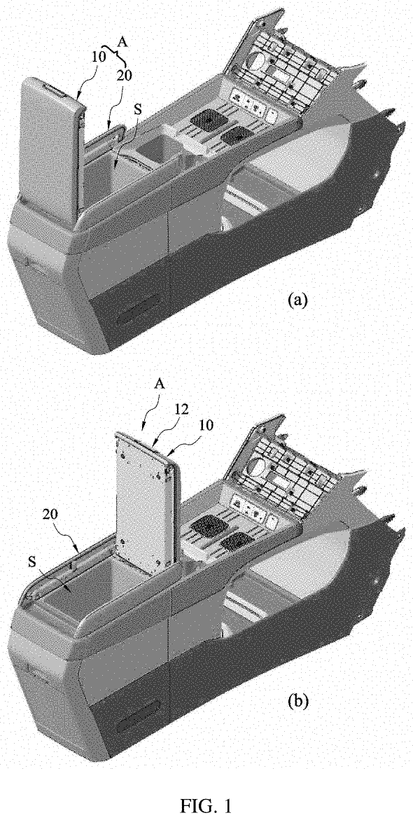

As illustrated in FIG. 1, a console installed between a driver seat and a passenger seat in a vehicle includes: a storage box S, which is a storage space; and an armrest A for opening and closing an open upper portion of the storage box S. Moreover, the armrest A according to the present invention includes: a center lid 10 for opening and closing the storage box S; and a pair of side lids 20 fixed to both sides of the top of the storage box S to support the center lid 10. The armrest A is installed on the top of the storage box S and is used to open and close the storage space of the storage box S.

The opening and closing device according to the present invention is applied to the armrest A of the console, and more specifically, is applied to the center lid 10 of the console A which is opened and closed bidirectionally, but the present invention is not limited thereto. FIG. 1A illustrates the center lid 10 opened backward, and FIG. 1(b) illustrates the center lid 10 opened forward. Here, to be selectively opened and closed forward and backward substantially means to be selectively opened and closed bidirectionally.

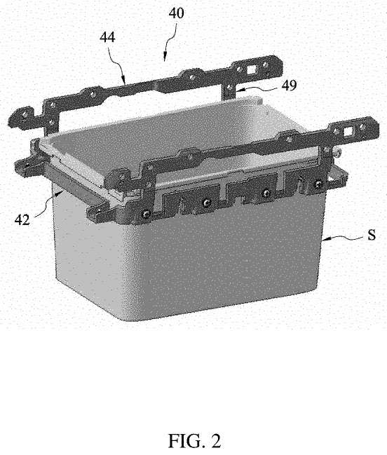

As illustrated in FIG. 2, a connection frame 40 includes: a lower frame 42 fixed to the outer side surface of the storage box S while getting in contact with the side surface of the storage box; and an upper frame 44 extending upward from the lower frame 42 and supported by side lids 20. The lower frame 42 and the upper frame 44 are connected by a connection part 49. Here, the connection part 49 is to connect the lower frame 42 and the upper frame 44, and is not limited by its shape. In the embodiment, the lower frame 42 is fixed to the outer surface of the storage box S while getting in contact with the outer surface of the storage box, but it is considered that the lower frame 42 cannot be limited thereto.

The lower frame 42 is a rectangular frame when viewed on a plane figure, and is designed to get in close contact with the outer surface of the storage box S. The lower frame 42 is fastened to the storage box S by a plurality of bolts or the likes to maintain a fastened state. The upper frame 44, which is made at the upper part by the connection part 49, is to support the side lids 20 in the fastened state, as described in detail below.

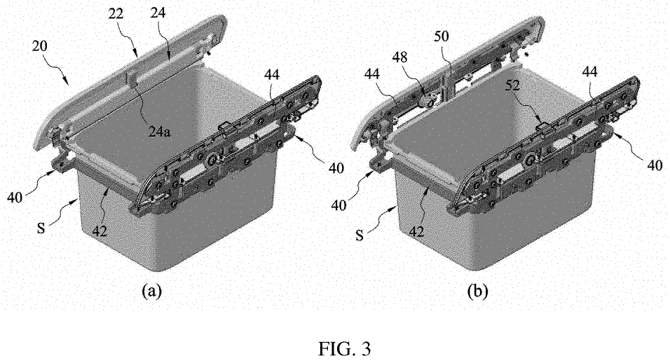

The connecting frame 40 used in the present invention is preferably formed of a metallic material which can have sufficient structural strength. For example, preferably, the connecting frame 40 is made of aluminum diecasting. Next, the structure of the upper frame 44 and the side lid 20 will be described with reference to FIG. 3.

Each of the side lids 20 of the armrest A includes an outer cover 22 and an inner cover 24. The outer cover 22 and the inner cover 24 are fixed and supported on the upper frame 44 mounted therebetween, for instance, by bolts. Therefore, the upper frame 44 is one component constituting the side lid 20, and it is preferable that the entire body of the frame 40 is made of aluminum diecasting.

Furthermore, according to the present invention, the side lid 20 includes a push member 50 supported upward by an elastic member, such as a spring. The push member 50 is to push the center lid 10 upward to a predetermined height when the release button 12 is pushed to release the locked state in the state in which the center lid 10 of the armrest is closed to be locked, and is mounted in the middle portion of the side lid 20.

That is, the push member 50 is mounted in the middle of the side lid 20, and the side lid 20 receives elastic force upwards by a spring. Therefore, when the locking force which closes the center lid 10 is removed, the push member 50 lifts the center lid 10 slightly upward, and it is called ‘initial opening’.

According to the present invention, the push member 50 is mounted in the middle portion of the side lid 20 so as to be applicable to the bidirectional opening and closing of the center lid in the same way. Since the center lid 10 is closed to maintain the locked state, the push member may use a member mounted on the side lid 20 or may be fastened and fixed at another portion of the armrest.

As illustrated in FIG. 3(a), since the push member 50 is supported to be vertically movable in a state in which the push member protrudes inward through a through hole 24a formed in the inner cover 24, the push member is mounted to push up the center lid 10 opened and closed between both side lids 20. Moreover, as illustrated in FIG. 4, the push member 50 is pressed upward by the elastic member 48, which is a torsion spring in this embodiment.

The push member 50 is supported to be movable in the vertical direction on the inner cover 24. For example, the push member 50 is supported to linearly move in the vertical direction by a guide 52 having a vertically tubular shape mounted on the inner cover 24. In addition, it would be easily understood by those skilled in the art that there are various embodiments of the push member 50, which is guided to move vertically by the inner cover 24.

In the embodiment illustrated in the drawings, an end portion of a torsion spring 48 is configured to push the push member 50 upward, but the present invention is not limited thereto, and it is natural to elastically support the push member 50 upward using the elastic force of various types of the spring. As described above, the push member 50 is mounted on the side lid 20 to be movable in the vertical direction and is elastically supported upward by the elastic member.

As illustrated in FIG. 3, the upper portion of the push member 50 according to the present invention has a bisected pork-shaped portion 52. A groove formed in the middle of the pork-shaped portion 52 is opened at the top. The pork-shaped portion 52 is coupled from bottom to top with respect to the inner cover 24. Therefore, the pork-shaped portion 52 is configured to stop at a predetermined height with respect to upward elastic force of the torsion spring 48.

The connection frame 40 made of aluminum diecasting includes: the lower frame 42 which has a substantially rectangular shape and getting in close contact with the outer surface of the storage box S; and the upper frame connected with the lower frame 42 by the connection part 49, forming a part of the side lid 20 and supporting the outer cover 22 and the inner cover 24. The inner cover 24 and the outer cover 22 are fixed and supported on the inside and outside of the upper frame 44, for instance, by bolts. Here, the connection frame 40 has sufficient structural strength since being formed of a metal material, thereby sufficiently and firmly supporting the armrest (center lid) opened and closed with respect to the fixed storage box S.

As described above, the present invention can sufficiently perform the initial opening of the center lid of the armrest since the push member is mounted in the middle of the side lid. Additionally, peripheral units of the push member according to the present invention can be used more usefully when the armrest is configured to be opened and closed bidirectionally. In addition, it would be easily understood that the connection frame 40 according to the present invention can strongly support the inner cover 24 of the side lid 20 and sufficiently reinforce the structural strength of the entire console.

What is claimed is:

1. A connection frame for a console of a vehicle, which includes a storage box having an open upper portion, and an armrest having side lids mounted at both sides of the upper portion of the storage box and a center lid supported by the side lids to open and close the storage box, the connection frame comprising:
a lower frame of which at least a portion gets in contact with the outer side surface of the storage box and is fixed to the storage box, and which has a rectangular shape; and
an upper frame extending upward from the lower frame to support the side lids mounted at both sides of the armrest.

2. The connection frame according to claim 1, wherein the side lid includes an outer cover and an inner cover, and the upper frame is interposed between the outer cover and the inner cover to couple and support the outer cover and the inner cover.
